(19) United States
(12) Patent Application Publication
(10) Pub. No.: US 2006/0061802 A1
(43) Pub. Date: Mar. 23, 2006

(54) Image processing apparatus

(75) Inventor: Kazuhiro Ogura, Yokohama-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/945,445

(22) Filed: Sep. 21, 2004

(51) Int. Cl. G06F 3/12

(52) U.S. Cl. 358/1.15

(57) ABSTRACT

An image processing apparatus includes a recognition unit which recognizes an operator on the basis of specification data for specifying the operator who operates the apparatus, a history manufacturing unit which manufactures history data relating the specification data of the operator with image data that is used when carrying out the image processing on the basis of an instruction by the operation, and a recording unit which records the history data manufactured by the history manufacturing unit.

### BACKGROUND OF THE INVENTION

1. Field of the Invention

The present invention relates to an image processing apparatus for storing data for managing processed image data.

2. Description of the Related Art

Jpn. Pat. Appn. KOKAI Publication No. 7-125328 discloses an image output apparatus such as a printer which stores management data with respect to a content of printing, history data with related to printing, and a content to be printed. Management data is the data with respect to items that are set in advance. For example, when outputting a check, this data means a number of check, a destination of transfer or the like. The management data stored in the image output apparatus can be outputted. By enabling to output the management data, a manager can know how the apparatus outputs the data. Therefore, illegal leakage of the content of printing and the history data by a user of the image output apparatus can be prevented so that security of the apparatus is protected.

According to such an image output apparatus, when the data stored in the apparatus flows out, the manager can check whether or not the actual content of printing and the history data flow out from the apparatus by checking the output management data. However, the manager cannot specify a person who leaked the information.

Accordingly, an image processing apparatus capable of increasing a deterrent to leakage of the stored data and enhancing security protection is needed.

### BRIEF SUMMARY OF THE INVENTION

According to an aspect of the present invention, an image processing apparatus comprises a recognition unit which recognizes an operator on the basis of specification data for specifying the operator who operates the apparatus; a history manufacturing unit which manufactures history data relating the specification data of the operator with image data that is used when carrying out the image processing on the basis of an instruction by the operation; and a recording unit which records the history data manufactured by the history manufacturing unit.

Objects and advantages of the invention will become apparent from the description which follows, or may be learned by practice of the invention.

### BRIEF DESCRIPTION OF THE SEVERAL VIEWS OF THE DRAWING

The accompanying drawings illustrate embodiments of the invention, and together with the general description given above and the detailed description given below, serve to explain the principles of the invention.

FIG. 1 is a schematic diagram showing an inner structure of an image processing apparatus according to a first embodiment of the present invention;

FIG. 2 shows a structure of a history manufacturing unit;

FIG. 3 shows a relation between a history table, an operator table, and an authority list table, respectively;

FIG. 4 is a flow chart showing processing of a MFP upon a copy operation;

FIG. 5 is a flow chart showing processing of a history manufacturing unit upon a copy operation;

FIG. 6 shows a structure of a history manufacturing unit according to a second embodiment of the present invention;

FIG. 7 is a table showing a character list;

FIG. 8 partially shows the history manufacturing unit;

FIG. 9 shows a display of a message to prompt certification of an individual;

FIG. 10 is a flow chart showing processing of the MFP upon a copy operation;

FIG. 11 shows a display of a message indicating that operation and an image are recorded;

FIG. 12 shows a display of a message indicating a warning;

FIG. 13 partially shows a history manufacturing unit according to a third embodiment of the present invention;

FIG. 14 is a flow chart showing processing of a MFP upon a scan operation;

FIG. 15 is a flow chart showing retrieve processing;

FIG. 16 is a flow chart showing processing of a MFP upon copy operation according to a fourth embodiment of the present invention;

FIG. 17 shows a display of a message indication that the image recording can be stopped;

FIG. 18 shows a display of a message indication that a reason of stopping is inputted; and

FIG. 19 shows a display of a message indicating that the image recording can be restarted.

### DETAILED DESCRIPTION OF THE INVENTION

With reference to the drawings, each embodiment according to the present invention when the present invention is applied to a multi function peripherals (MFP) having various functions such as a copy function, a printer function, a network scanner function and the like are described below.

### First Embodiment

FIG. 1 is a schematic diagram showing an inner structure of an MFP 1. The MFP 1 is configured by a control device 11, a real time clock (RLC) 12, an operational panel 13, a scanner 14, a raster image processor (RIP) 15, an image processing unit 16, a history manufacturing unit 17, an individual certification device 18, a history recording unit 19, a printing device 20, a network control device 21, and a network scanner compression unit 22. The control device 11, the RTC 12, the operational panel 13, the scanner 14, the RIP 15, the image processing unit 16, the history manufacturing unit 17, the individual certification device 18, the history recording unit 19, the printing device 20, the network control device 21, and the network scanner compression unit 22 are connected each other via a bus line 23.

The control device 11 is configured by a CPU, a ROM, a RAM and the like. The control device 11 generally controls the entire MFP 1. The RTC 12 generates current time information.

The operational panel 13 has an operation unit 131 in which a numeric keypad, a start key and the like for instructing the control device by a user are disposed, and a display unit 132 for displaying various information to be informed to the user and accepting input of the instruction, for example, a plain display of a touch panel.

The scanner 14 reads images from a document that is mounted on a document table (not illustrated) and a plurality of documents that are continuously fed from an auto document feeder (ADF) and generates image data. The operation and configuration of reading the image data of the scanner 14 is the same as the conventional one, so the explanation thereof is herein omitted.

The RIP 15 accepts a printing instruction by a page description language such as PostScript or the like from the network control device 21 to generate print data of a raster format.

The image processing unit 16 performs the image processing suitable for printing to the image data.

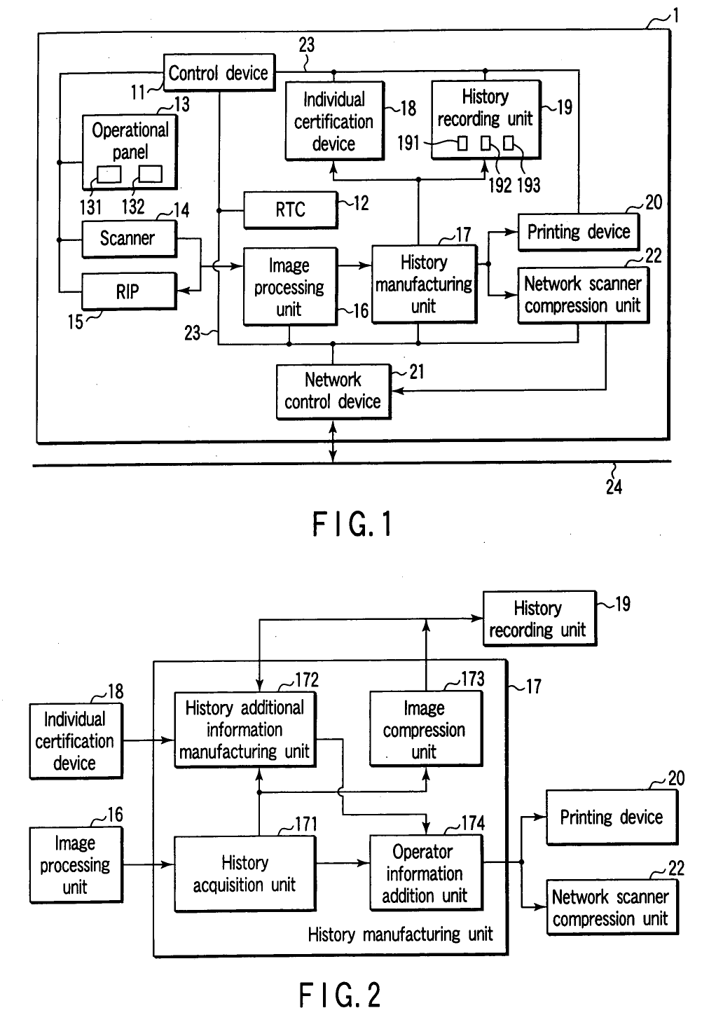

The history manufacturing unit 17 manufactures history data of the image data to be processed by the MFP 1. As shown in FIG. 2, the history manufacturing unit 17 has a history acquisition unit 171, a history additional information manufacturing unit 172, an image compression unit 173, and an operator information addition unit 174. In the meantime, this history manufacturing unit 17 may be configured by hardware realized by a circuit or the like or may be configured by software to be realized by execution of a control program by means of a CPU.

The history acquisition unit 171 extracts the image data from the image data transmitted from the image processing unit 16 to generate thumbnail data. Then, the history acquisition unit 171 transmits this thumbnail data to the history additional information manufacturing unit 172 and the image compression unit 173. In addition, the history acquisition unit 171 transmits the data that is transmitted from the image processing unit 16 to the operator information addition unit 174 as it is.

The history additional information manufacturing unit 172 manufactures history data in which an operator ID as the specification data to be transmitted from the individual certification device 18, thumbnail data to be transmitted from the history acquisition unit 171, and data indicating the kind of operation to be acquired through the control device 11 or the like are related, and records this manufactured history data to the history recording unit 19. In addition, the history additional information manufacturing unit 172 transmits a name of the operator in response to the operator ID that is specified by using an operator table 192 (to be described later) recorded in the history recording unit 19 and the additional data indicating the current time or the like generated by the RTC 12 to the operator information addition unit 174.

The image compression unit 173 compresses the image data transmitted from the history acquisition unit 171 and transmits the compressed image data to the history recording unit 19. Before compression of the image data, a size of the image data may be decreased by the following processing. For example, this processing includes processing to add eight colors to the image data, processing to make the image data into a gray scale, processing to make the image data into monochrome, and processing to further decrease the size of the image data. After the processing is executed, image compression unit compress the image data. So, the size of image data is decreased.

The operator information addition unit 174 adds the name of the operator acquired from the history additional information manufacturing unit 172 and the additional data indicating the current time or the like to the image data transmitted from the history acquisition unit 171. In this addition, for example, the additional data is added at a place which becomes a margin when the image data is printed or the additional data is added in the image so as to be a watermark. This addition may be set by a system manager of the MFP 1, for example, when installing the MFP 1.

The individual certification device 18 is an apparatus capable of specifying the operator (the individual). For example, the individual certification device 18 is an IC card reader, a finger print verifier, an iris verifier or the like. Comparing the specification data (for example, data showing the number of an IC card, a finger print, and an iris) for specifying the operator read by the individual certification device 18 in this way, the individual certification device 18 verifies the operator. When the operator is verified in this way, the individual certification device 18 transmits the operator ID as the specification data for specifying the verified operator to the history additional information manufacturing unit 172. Since the IC card reader, the finger print verifier, and the iris verifier are the same as the conventional ones, their explanation is herein omitted.

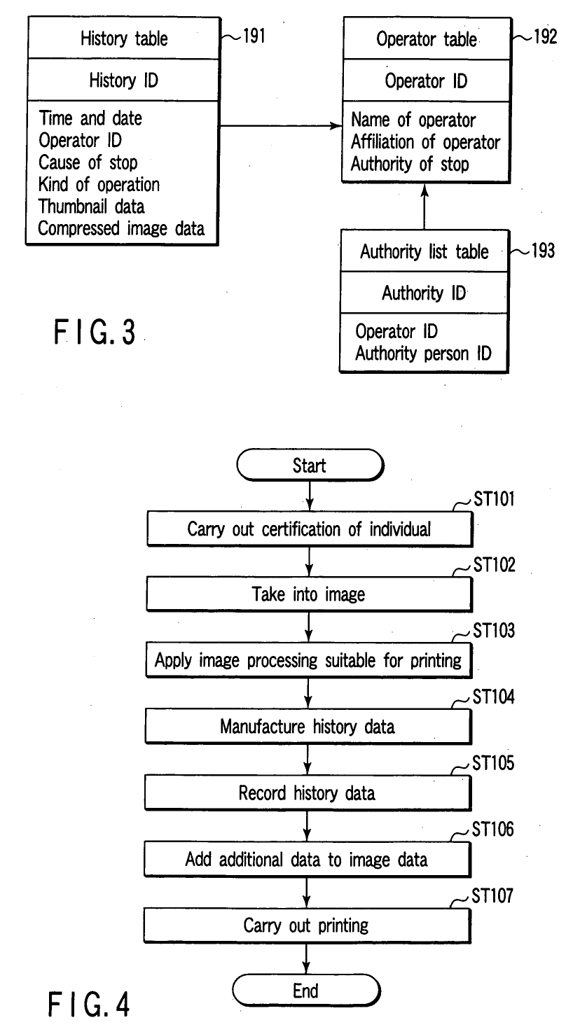

The history recording unit 19 is a recording unit for recording history data. This history recording unit 19 is, for example, a database managing system. This history recording unit 19 is provided with an area for storing a history table (recording unit) 191 for storing history data, an operator table (an operator data storage unit) 192 for storing operator data, and an authority list table (an authority list data storage unit) 193 for storing an authority list. With reference to FIG. 3, a scheme of each table to be managed by the history recording unit 19 will be described below.

As shown in FIG. 3, the history table 191, the operator table 192, and the authority list table 193 are related with each other. In the history table 191, a set of the history ID, a time and date, the operator ID, a cause of stop, the kind of the operation, the thumbnail data, and the compressed image data is recorded whenever the operator operates the operation such as copying, printing, network scanning and the like. The history ID is an ID that is dedicated to each set in the history table 191 and is a counter that is increased one by one from 0 for each set. The time and date are a time and date when the operator carries out the operation. The operator ID is an ID that is transmitted from the individual certification device 18 and that is allocated for each operator. This operator ID separately manages the details with the operator table 192. With respect to the cause of stop, on the basis of the authority that is set in the authority list table 193 (to be described later), a cause of stop when stopping record of the compressed image data and the thumbnail data is recorded in the history table 191. With respect to the kind of operation, the kind of operation such as copying, printing, network scanning or the like that is carried out by the operator is stored. The thumbnail data is a contraction of the image data that is processed. The compressed image data is image data compressed by the image compression unit 173.

The operator table 192 stores a set of the operator ID, the name of the operator, affiliation of the operator, and the stop authority therein. One set is represented for each operator. The stop authority is an authority to stop recording of the compressed image data and the thumbnail data in the history table 191. Assuming that the stop authority is not set in these first, second, and third embodiments, in a fourth embodiment to be described later, a case that the stop authority is set will be described.

The authority list table 193 stores a list of the authority ID with respect to a person who has an authority capable of retrieving and referring to the history data such as the compressed image data or the like of the operation carried out by the operator therein. Accordingly, the authority ID stores the operator ID of the operator who carries out the operation and the ID of an authority person who is a manager of the operator. According to this embodiment, by storing the operator ID in the area of the authority person ID, the authority person ID is set. In other words, the operator of which operator ID is set in the area of the authority ID can retrieve and refer to the history data of the operator ID that is related to the authority person ID.

The history recording unit 19 may be configured not in the MFP 1 but on a network 24. The history recording unit 19 can be retrieved and referred to from a PC (not illustrated) or the like that is connected to the network 24 via the network control device 21.

If image data is inputted, the printing device 20 forms an image on the basis of this image data. For example, the printing device 20 is formed in an ink jet system or in an electronic photographic system. Since the configuration and the operation for generating an image on the basis of the image data of this printing device 20 are the same as the conventional ones, their explanations are herein omitted.

The network control device 21 connects the MFP 1 to the network 24. The network control device 21 controls the communication with the outside PC or the like that is connected to the network 24 under the control of the control device 11.

The network scanner compression unit 22 is a format converting device for converting the image data read by the scanner 14 into a general graphic format (for example, a joint photographic experts group (JPEG)).

However, upon applying the present invention, the scanner 14, the RIP 15, the network control device 21, the printing device 20, and the network scanner compression unit 22 are not always necessary from among the above-described configurations. In other words, the present invention can be applied not only to a complex machine such as the MFP 1 but also to the embodiments such as a copying machine having the scanner 14 and the printing device 20, a network printer having the network control device 21, the RIP 15, and the printing device 20, and a network scanner having the scanner 14, the network scanner compression unit 22, and the network control device 21.

Consequently, with reference to FIG. 4, a flow of the processing of the MFP 1 when the operator registered in the individual certification device 18 carries out the copy operation by using the MFP 1 will be described below. At first, the individual certification device 18 accepts the operation of the operator, carries out the certification of the individual, and outputs the operator ID allocated to the operator to the history manufacturing unit 17 (ST101). Then, the scanner 14 takes in the image of the document that is mounted on a prescribed position to generate the image data. The scanner 14 outputs the generated image data to the image processing unit 16 (ST102). The image processing unit 16 applies the image processing that is suitable for printing to the image data transmitted from this scanner 14 and outputs it to the history manufacturing unit 17 (ST103). After generating the additional data on the basis of the specification data transmitted from the individual certification device 18, the history manufacturing unit 17 manufactures history data from this additional data, the image data transmitted from the scanner 14, the data acquired via the control device 11 and the like (ST104) to record this manufactured history data in the history recording unit 19 (ST105). In addition, the history manufacturing unit 17 carries out the processing to add the additional data to the image data (ST106). The printing device 20 carries out printing on the basis of the image data to which the additional data transmitted from the history manufacturing unit 17 is added (ST107).

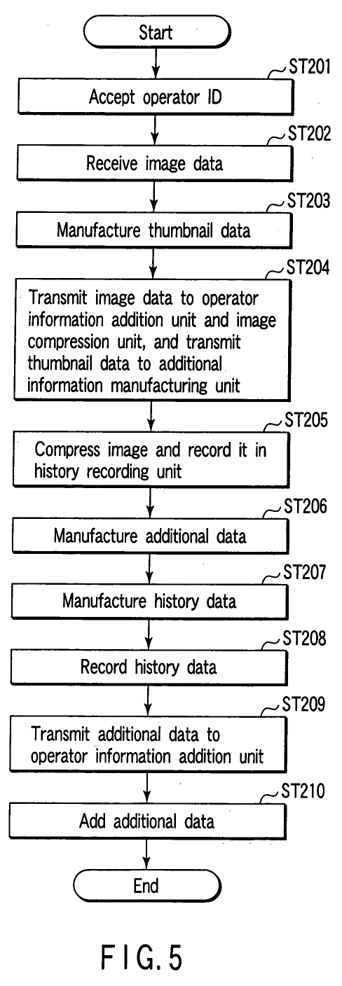

Next, a flow of the processing of the history manufacturing unit 17 in steps ST104, ST105, and ST106 will be described more in detail with reference to FIG. 5. At first, the history additional information manufacturing unit 172 accepts the operator ID that is certified by the individual certification device 18 (ST201). Then, the history acquisition unit 171 receives the image data after the image processing is applied by the image processing unit 16 (ST202). Then, the history acquisition unit 171 manufactures the thumbnail data from the received image data (ST203), transmits the image data to the operator information addition unit 174 and the image compression unit 173, and transmits the thumbnail data to the history additional information manufacturing unit 172 (ST204). Then, the image compression unit 173 compresses the received image data to record it in the history recording unit 19 (ST205). With reference to the operator table 192 from the operator ID, the history additional information manufacturing unit 172 manufactures the name of the operator and manufactures the additional data such as the time and date or the like from the RTC 12 (ST206). The history additional information manufacturing unit 172 manufactures the history data such that the manufactured additional data, the data showing the kind of the operation that is acquired via the control device 11, and the compressed image data stored in the history recording unit 19 are paired (ST207). The history additional information manufacturing unit 172 records this history data in the history recording unit 19 (ST208). The history additional information manufacturing unit 172 also transmits the manufactured additional data to the operator information addition unit 174 (ST209). The operator information addition unit 174 adds the additional data, for example, to the margin of the image that is indicated by the image data received from the history acquisition unit 171 (ST211).

According to the MFP 1 of this first embodiment, whenever the operator caries out the operation, in relation to the operator ID that belongs to the operator, the time and date of the operation, the image data, the kind of the operation and the like are recorded in the history table 191 of the history recording unit 19 as the history data. Therefore, if the MFP 1 is illegally used, the system manager can specify the person who used the MFP 1 illegally by collating the history data recorded in the history table 191. Accordingly, it is possible to increase a deterrent to the illegal usage of the MFP 1, to prevent leakage of the stored data, and to enhance protection of the security.

Further, the history data recorded in the history table 191 may be encrypted when it is recorded. By encoding the history data in this way, unless a cipher key is used, the history data recorded in the history table 191 cannot be retrieved and referred to. In this case, a key to decode the encrypted data is given, for example, for each operator, or a different key is given for each prescribed group. Thus, according to such a configuration, it is possible to further enhance protection of security.

### Second Embodiment

Next, a second embodiment of the present invention will be described below. The same numeral references are given to the same parts as the above-described first embodiment and its detailed explanation is herein omitted.

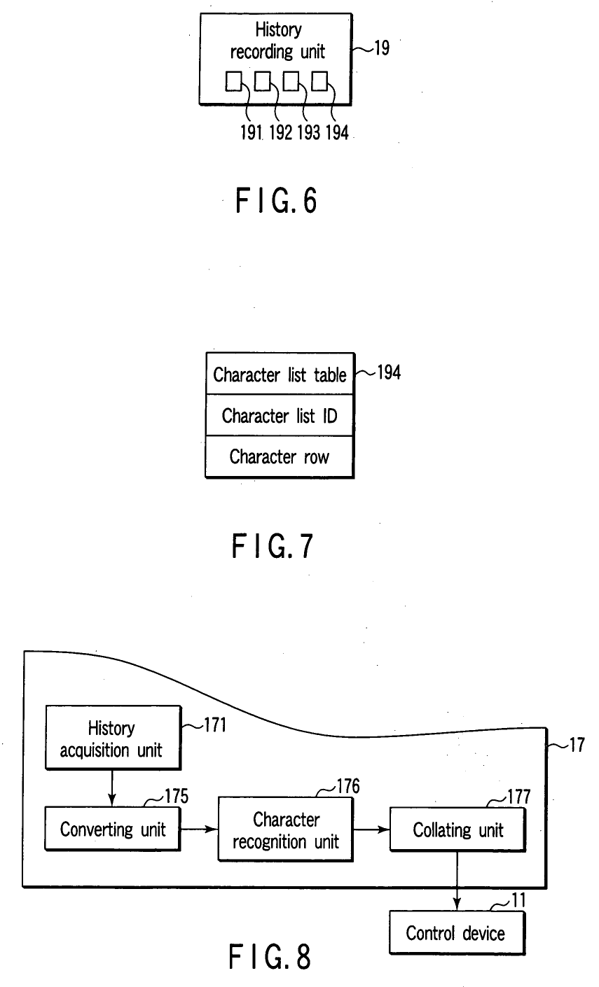

As shown in FIG. 6, in the MFP 1 according to the second embodiment, the history recording unit 19 is provided with an area to store a character list table (a character list data storage unit) 194. This character list table 194 stores a set of character rows that are printed in a security document or the like of which copying, printing, network scanning and the like are prohibited, for example, “secret” and “a customer list” and the character list ID.

Further, as shown in FIG. 8, the history manufacturing unit 17 is further provided with a converting unit 175 for converting image data into data from which a character can be read, a character recognition unit 176 for recognizing the character from this converted data, and a collating unit 177 for collating the characters acquired from a recognition result of the character recognition unit 176 against the characters stored in the character list. The collating result of this collating unit 177 is outputted to the control device 11.

Moreover, the MFP 1 displays a message indicating that the operation including the image is recorded if the operator carries out the operation on the display unit 132 and further, displays a warning, for example, a message indicating a confidential document on the display unit 132.

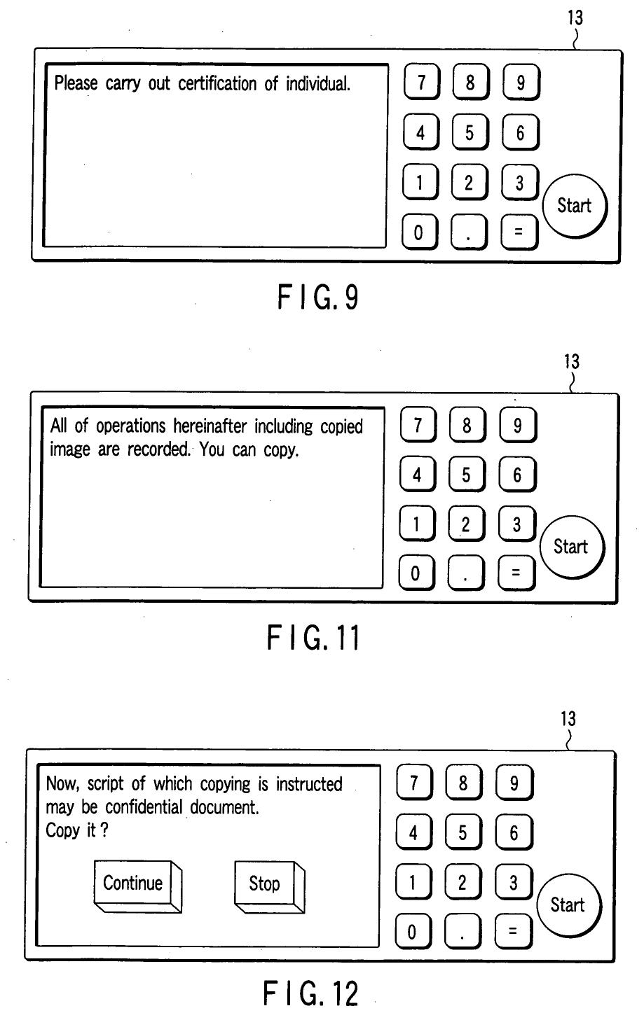

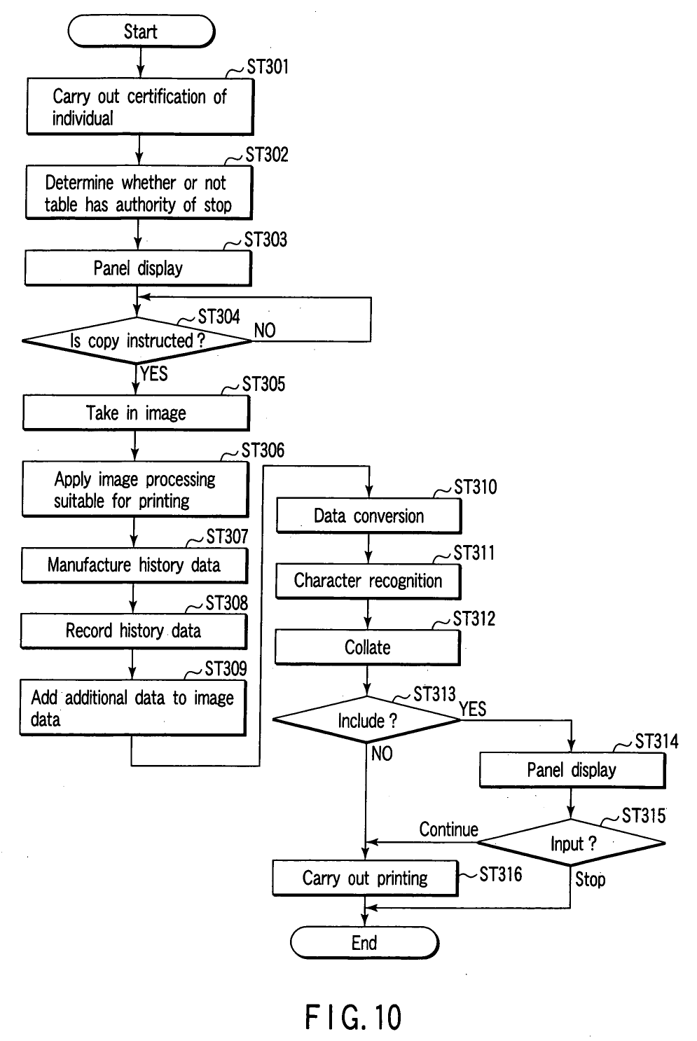

In the MFP 1 of the second embodiment that is configured as described above, in a standby mode, a message to prompt certification of the individual is displayed on the display unit 132 of the operational panel 13 as shown in FIG. 9. Hereinafter, with reference to FIG. 10, the case of mounting the document on the document table and making the MFP 1 to copy after the operator performs the certification of the individual will be described.

At first, accepting the operation of the individual certification device 18 and carrying out the certification of the individual, the operator ID allocated to the operator is outputted to the history manufacturing unit 17 (ST301). Then, the control device 11 determines whether or not the stop authority is set in the operator table 192 on the basis of the operator ID (ST302). On the basis of this determination result (in this second embodiment, the stop authority is not set), the display unit 132 of the operational panel 13 displays the message to prompt that the operation including the image is recorded if the operation is carried out as shown in FIG. 10 (ST303). Subsequently, when the control device 11 accepts input from of the start key from the operation unit 131 (YES in ST304), the processing proceeds to step ST305. Since the processing from step ST305 to ST309 are the same as those from step ST102 to ST106, their explanations are herein omitted.

Then, the converting unit 175 converts the image data acquired from the history acquisition unit 171 such that the character can be recognized (ST310). For example, the character recognition unit 176 as an optical character recognition (OCR) performs the character recognition processing with respect to this converted data (ST311). The collating unit 177 collates the characters acquired from the result of the character recognition processing against the characters of each character list ID stored in the character list table 194 (ST312). The control device 11 determines whether or not the characters stored in the character list table 194 are included in the image data on the basis of this collating result (ST313). In this determination, if YES, the control device 11 displays a message indicating the confidential document on the display unit 132, for example, as shown in FIG. 11 (ST314), and it determines whether or not any instruction of “Continue” or “Stop” is received (ST315). In this determination, if it is determined that “Continue” is instructed, in the case of NO in the determination of step ST311, the control device 11 controls the printing device 20 or the like to carry out printing of the image data (ST316). If printing is carried out and the instruction of “Stop” is accepted in step ST314, the processing is terminated.

According to the MFP 1 of this second embodiment, in a standby mode, a message indicating that the operation including the image is recorded if the operation is carried out is displayed. When processing the image data including the characters collated against the characters stored in the character list table 194, a message indicating the confidential document is displayed. Therefore, it is possible to increase a deterrent to the illegal usage of the MFP 1, to prevent leakage of the stored data, and to further enhance the protection of security.

### Third Embodiment

Next, a third embodiment of the present invention will be described below. The same numeral references are given to the same parts as the above-described first embodiment and its detailed explanation is herein omitted.

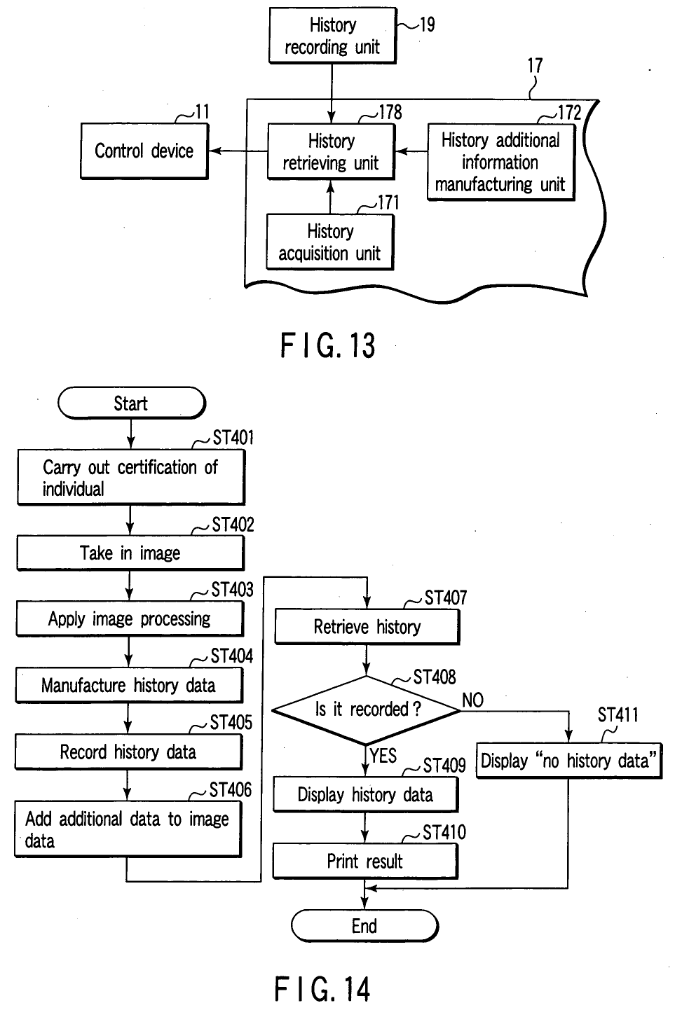

As shown in FIG. 13, in the MFP 1 according to the third embodiment, the history manufacturing unit 17 is further provided with a history retrieving unit 178. The history retrieving unit 178 retrieves whether or not image data that substantially complies with the image data to be processed is recorded in the history recording unit 19. Processing the image data when the operations of scanning and copying are carried out, the MFP 1 configured in this manner displays the name of the operator who processes the image data on the display unit 132 when the approximately same processing of the image data is carried out in the past.

With reference to FIG. 14, the case of making the MFP 1 to scan the document after the operator mounts the document on the document table to perform the certification of the individual will be described below. In the meantime, the processing from step ST401 to step ST406 are the same as those from step ST101 to step ST106, and their explanations are herein omitted.

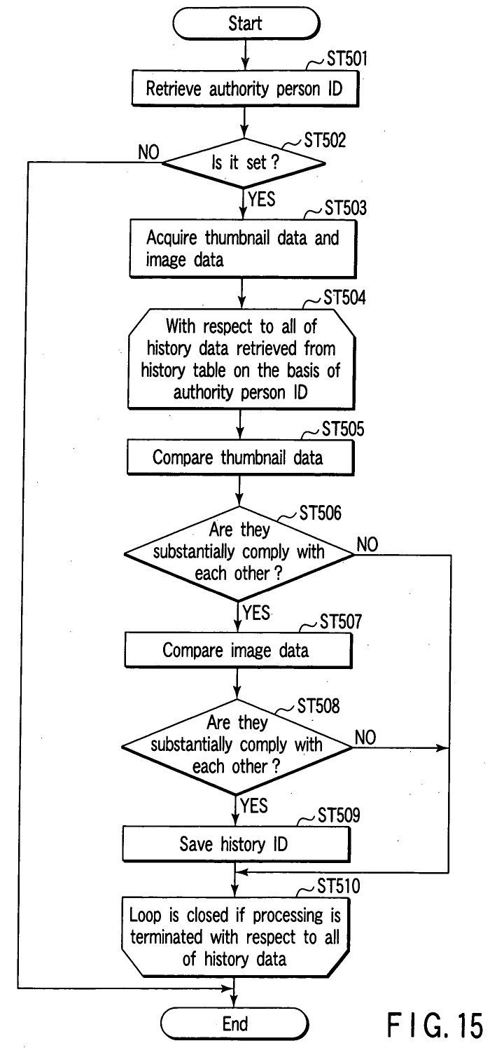

The history retrieving unit 178 retrieves whether or not image data that substantially complies with the image data transmitted from the image processing unit 16 is recorded in the history recording unit 19 (ST407). The detailed explanation of this retrieving processing will be described later with reference to FIG. 15. The control device 11 determines whether or not the image data that substantially complies with the image data transmitted from the image processing unit 16 is recorded in the history table 191 of the history recording unit 19 on the basis of a result of this retrieving processing to be described later, specifically depending on if the history ID is stored in the prescribed storage area as a result of the retrieving processing (ST408). If YES in this determination, the display unit 132 displays the history data that is related to the retrieved history ID, for example, the name of the operator, the time and the day when the operation is performed, and the kind of the operation (ST409). The printing device 20 prints the operation including the image indicated by the image data in addition to the result of display, for example, the name of the operator, the time and the day when the operation is performed, and the kind of the operation (ST410) to terminate the processing. If NO in the determination of step ST408, the display unit 132 displays “No history data” (ST411) to terminate the processing.

Subsequently, the retrieving processing of step ST407 will be described with reference to FIG. 15. The history retrieving unit 178 retrieves an authority list that the operator ID is an authority person ID after acquiring the operator ID from the history additional information manufacturing unit 172 (namely, the operator is set as the authority person who has an authority to retrieve the history table 191 or the like) from the authority list table 193 (ST501). Then, the history retrieving unit 178 determines whether or not the acquired operator ID is set as the authority person ID from the result of the retrieving (ST502). If the operator ID is not set as the authority person ID, the processing is terminated because the operator has no authority to check the history data of others recorded in the history table 191 of the history recording unit 19. If the operator ID is set as the authority person ID, the history retrieving unit 178 acquires the thumbnail data and the compressed image data from the history acquisition unit 171 (ST503). Then, the history retrieving unit 178 carries out the processing from step ST504 to step ST510 with respect to all of the history data retrieved from the history table 191 on the basis of the authority person ID. In the retrieving of the history data, specifically, the history data related to the operator ID corresponding to the authority person ID in the authority list set as the authority person ID is retrieved from the history table 191. At first, the history retrieving unit 178 compares the thumbnail data acquired from the history acquisition unit 171 with the thumbnail data recorded in the retrieved history data (ST505) to determine whether or not respective thumbnail data substantially comply with each other (ST506). If the history retrieving unit 178 determines that they match each other, comparing the image data acquired from the history acquisition unit 171 with the compressed image data recorded in the history data (since the image data is compressed and recorded, after performing the extension processing, it is compared with the image data) (ST507), the history retrieving unit 178 determines whether or not respective image data substantially comply with each other (ST508). If the history acquisition unit 171 determines that they match each other, the history acquisition unit 171 stores the history ID of the history table 191 that is related to the image data in the predetermined storage area (ST509). When saving the history ID, or when determining that respective thumbnail data or respective image data do not match each other, the processing will proceed to step ST510. Returning to step ST504 untill the above-described processing is terminated with respect to all of the retrieved history data, if the above-described processing is terminated with respect to all of the retrieved history data, a loop is closed (ST510) to terminate the retrieving processing.

According to the MFP 1 of this third embodiment, carrying out the processing of the image data when scanning or the like is operated, if the image data that substantially complies with the image data to be processed is recorded in the history recording unit 19, the name of the operator who performs the processing of the image data, the time and the day of the operation, the kind of the operation and the like are displayed on the display unit 132, and further, printing is automatically carried out with the image data added to this information. Therefore, in the case that the MFP 1 is illegally used so that the confidential document such as a customer list or the like is copied and leaked, the system manager can easily specify the person who illegally uses the MFP 1 by making the MFP 1 to read the leaked confidential document such as the customer list or the like. Accordingly, it is possible to increase a deterrent to the illegal usage of the MFP 1, to prevent leakage of the stored data, and to enhance the protection of security.

Further, when the operator retrieves the history data, with reference to the authority list table 193, the MFP 1 can retrieve only the history data of the operator to whom the authority to retrieve and refer to the recorded image data. In other words, the MFP 1 cannot retrieve and refer to the history data if the operator is not given the authority. Accordingly, it is also possible to protect privacy with respect to each operator of the MFP 1.

Moreover, when retrieving the image data that complies with the image data processed by scanning or the like, at first, the MFP 1 compares the thumbnail data with each other. Then, when the thumbnail data match each other, the MFP 1 compares the image data with each other. Therefore, the MFP 1 can speed up the retrieving processing.

### Forth Embodiment

Next, a fourth embodiment of the present invention will be described below. The same numeral references are given to the same parts as the above-described first embodiment and its detailed explanation is herein omitted. In this fourth embodiment, the case that the operator whose the stop authority is set in the operator table 192 operates the MFP 1 will be described below. Upon setting this stop authority, for example, providing an area of a stop flag in the control device 11, the stop flag is set at, for example, “true” (in a default state, it is set at “true”), and when stopping recording of the image, the stop flag is set at “false”. The MFP 1 performs the processing in response to respective setting.

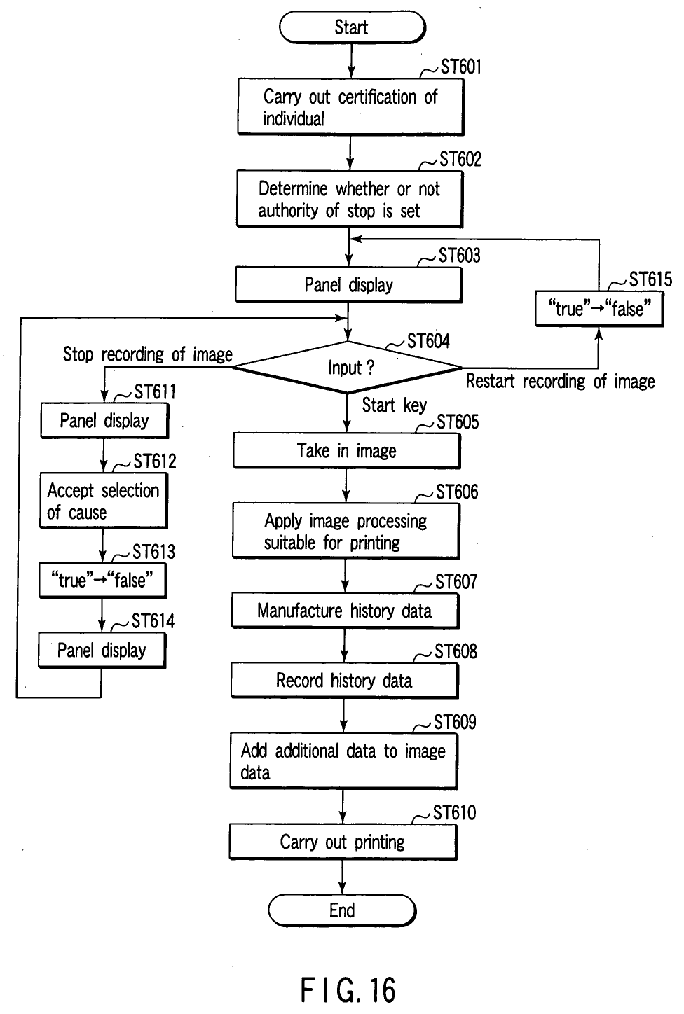

With reference to FIG. 16, a flow of the processing of the MFP 1 when the operator who is registered in the individual certification device 18 and whose stop authority is set in the operator table 192 uses the MFP 1 to carry out the copy operation will be described below. In this MFP 1, a message to prompt the certification of the individual shown in the above-described FIG. 9 is displayed in a standby mode.

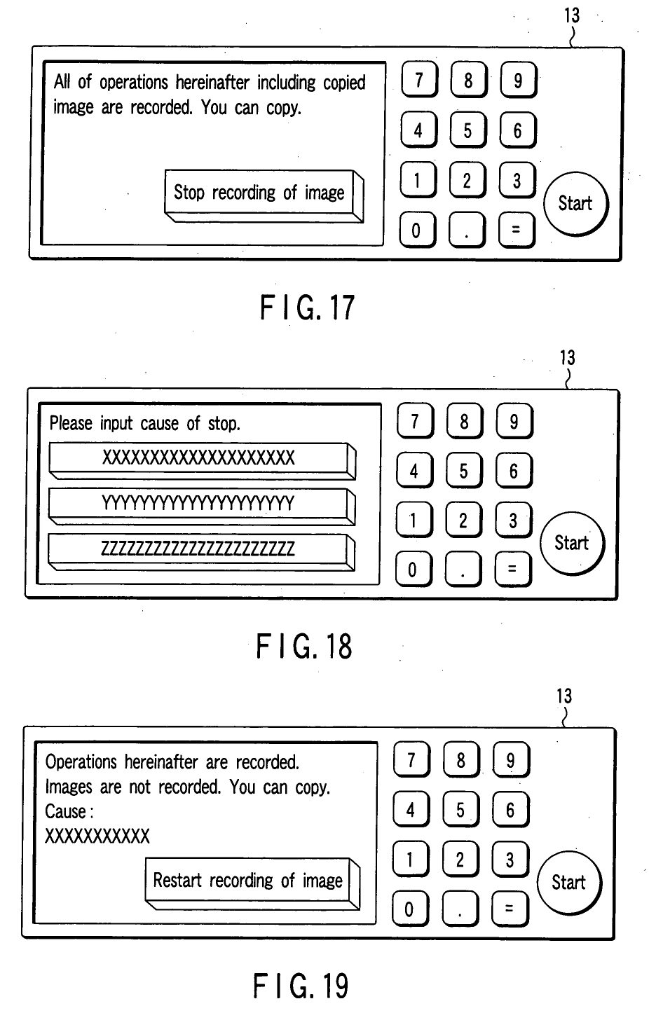

The individual certification device 18 executes the certification of the individual when accepting the operation of the operator and outputs the operator ID that is allocated to the operator to the history manufacturing unit 17 (ST601). Then, the control device 11 determines whether or not the stop authority is set in the operator table 19 on the basis of the operator ID (ST602). On the basis of the result of the determination (in this fourth embodiment, the stop authority is set), the display unit 132 of the operational panel 13 displays an image recording stop key capable of stopping recording of the image together with a message to prompt that the operation including the image is recorded if the operation is performed as shown in FIG. 17 (ST603). Subsequently, the control device 11 determines what input it accepts from the operational panel 13 (ST604). If this input is the input of the “start” key, since the stop flag is set at “true” in a default state, the processing from step ST605 to step ST610 can be carried out in the same way as the processing from step ST102 to step ST107 described in the first embodiment. If the input accepted in step ST604 is “stop of image recording”, the display unit 132 of the operational panel 13 displays a message to accept the input to select a cause of stop as shown in FIG. 18 (ST611). Then, accepting the input to select the cause of stop, the control device 11 sets the stop flag from “true” to “false” (ST613). Then, as shown in FIG. 19, the display unit 132 of the operational panel 13 displays a message that the image is not recorded even if the operation is recorded, selected the cause of stop, and an image recording restart key for restarting the image recording (ST614) and the processing will return to step ST604 in order to accept a next instruction. If the input accepted in step ST604 is “an image record restart”, setting the stop flag from “false” to “truer (ST615) and returning to the processing of step ST603, the display unit 132 of the operational panel 13 displays the message described with reference to FIG. 17. With the display shown in FIG. 19 (namely, the stop flag is set at “false”), accepting the input of the start key, when manufacturing the history data in step ST607, the thumbnail data and the image data are not stored in the history recording unit 19. In other words, the name of the operator, the time and the day of the operation, the kind of the operation and the like are recorded as the history data of the history table 191, but the thumbnail data and the image data are not recorded. As the history data of the history table 191 in this case, the cause of stop accepted in step ST612 is recorded. In the meantime, in the processing from step ST604 to step ST609, when the stop flag is set at “false” (except for the processing of ST607), the same processing as the processing from step ST102 to step ST107 (except for the processing of ST105) described in the first embodiment are carried out.

According to the MFP 1 of this fourth embodiment, if the operator would not like to leave the image data in the MFP 1, the operator can stop to store the image data in the history table 191 of the history recording unit 19. Thus, the image data is not stored, so that it is possible to prevent leakage of the information.

In addition, only the operator whose the stop authority is set in the operator table 192 can stop recording of the image data in the MFP 1, and in the case of stopping recording of the image data, the cause of stop is also recorded in addition to the name of the operator, the time and the day of the operation, the kind of the operation and the like, so that it is recorded when and what operation a person having the stop authority carries out. Since the system manager can confirm such information, it is possible to increase a deterrent to the illegal usage of the MFP 1 even with respect to the person having the stop authority, to prevent leakage of the stored data, and to enhance the protection of security.

According to the present embodiment, a case that the functions to practice the invention are recorded in advance inside of the apparatus is described. However, the present invention is not limited to this and the same functions may be downloaded from the network to the apparatus, or a recording medium having the same functions stored therein may be installed in the apparatus. As the recording medium, if it can store a program such as a CD-ROM or the like and can be read by the apparatus, any formation may be possible. In addition, a function that is acquired by installing and downloading in advance may realize its function in cooperation with an operating system (OS) or the like inside of the apparatus.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing apparatus comprising:
a recognition unit which recognizes an operator on the basis of specification data for specifying the operator who operates the apparatus;
a history manufacturing unit which manufactures history data relating the specification data of the operator with image data that is used when carrying out the image processing on the basis of an instruction by the operation; and
a recording unit which records the history data manufactured by the history manufacturing unit.

2. The image processing apparatus according to claim 1, wherein the recording unit comprises an operator data storage unit which stores the operator data with related to an operator indicated by the specification data in response to the specification data.

3. The image processing apparatus according to claim 2, further comprising a printing unit which prints the data,
wherein the history manufacturing unit adds at least data indicating a name of the user to the image data and the printing unit carries out printing on the basis of the added data.

4. The image processing apparatus according to claim 1,
wherein the history manufacturing unit manufactures thumbnail data for a thumbnail from the image data, compresses the image data, and manufactures the compressed image data, and the recording unit records the thumbnail data and the compressed image data.

5. The image processing apparatus according to claim 1, further comprising an operation unit which accepts an instruction of a user, and a display unit which displays information to the user,
wherein the display unit displays a message to indicate that the history of the operation and the image are recorded when the operation unit receives the instruction.

6. The image processing apparatus according to claim 5, wherein the recording unit comprises a character list data storage unit which stores a character list.

7. The image processing apparatus according to claim 6, wherein the history manufacturing unit further comprises a converting unit which converts the image data into data of which character can be recognized when the operating unit accepts the instruction; a character recognition unit which recognizes a character from the converted data; and a collating unit which collates a character from a recognition result of the character recognition unit against the characters stored in the character list, and
the display unit displays a message indicating a warning when the collating unit collates that the character from the recognition result of the character recognition unit is identified with the characters stored in the character list.

8. The image processing apparatus according to claim 1, further comprising:
a retrieving unit which, when carrying out the image data on the basis of the instruction by the operation, retrieves whether or not image data that substantially complies with the image data is recorded in the recording unit; and
a display unit which, if the retrieving unit retrieves the image data, displays user data recorded with related to the retrieved image data.

9. The image processing apparatus according to claim 4, further comprising:
a retrieving unit which, when carrying out the image data on the basis of the instruction by the operation, retrieves whether or not thumbnail data that substantially complies with the thumbnail data is recorded in the recording unit; and
a display unit which, if the retrieving unit retrieves the thumbnail data, displays user data recorded with related to the retrieved thumbnail data.

10. The image processing apparatus according to claim 1, wherein the history data to be recorded in the recording unit is encrypted.

11. The image processing apparatus according to claim 1, wherein the recording unit comprises an authority list data storage unit which stores authority list data indicating that the recording unit has an stop authority to stop recording of the image data.

12. The image processing apparatus according to claim 11, further comprising:
a determination unit which, when the recognition unit performs recognition and accepts the specification data, determines whether or not a user specified by the specification data has the stop authority;
an input unit to input a cause of stop when the determination unit determines that the user has the stop authority; and
a stop unit which, when the cause of stop is inputted, stops recording of the image data in the history data.

13. A method of processing an image of an image processing apparatus, comprising:
certifying an operator on the basis of specification data for specifying the operator who operates the apparatus;
manufacturing history data relating the specification data of the operator with image data that is used when carrying out the image processing on the basis of an instruction by the operation; and
recording the manufactured history data.

14. The method of processing an image of an image processing apparatus, according to claim 13, further comprising:
when carrying out the image data on the basis of the instruction by the operation, retrieving whether or not image data that substantially complies with the image data is recorded; and
if the image data is retrieved, displaying user data recorded with related to the retrieved image data.

15. The method of processing an image of an image processing apparatus, according to claim 13, further comprising:
when accepting the specification data, determining whether or not a user specified by the specification data has the stop authority to stop recording of the image data;
when determining that the user has the stop authority, accepting input of a cause of stop; and
when the cause of stop is inputted, stopping recording of the image data.

16. A computer program for causing an image processing apparatus to function, comprising:
means for certifying an operator on the basis of specification data for specifying the operator who operates the apparatus;
means for manufacturing history data relating the specification data of the operator with image data that is used when carrying out the image processing on the basis of an instruction by the operation; and
means for recording the manufactured history.

17. The computer program for causing an image processing apparatus to function, according to claim 16, comprising:
means for, when carrying out the image data on the basis of the instruction by the operation, retrieving whether or not image data that substantially complies with the image data is recorded; and
means for, if the image data is retrieved, displaying user data recorded with related to the retrieved image data.

18. The computer program for causing an image processing apparatus to function, according to claim 16, comprising:
means for, when accepting the specification data, determining whether or not a user specified by the specification data has the stop authority to stop recording of the image data;
means for, when determining that the user has the stop authority, accepting input of a cause of stop; and
means for, when the cause of stop is inputted, stopping recording of the image data.
